(19) United States
(12) Patent Application Publication
(10) Pub. No.: US 2002/0049727 A1
(43) Pub. Date: Apr. 25, 2002

(54) Method and apparatus for providing customized information

(76) Inventor: David Rothkopf, Washington, DC (US)

Correspondence Address: COVINGTON & BURLING, ATTN: PATENT DOCKETING, 1201 PENNSYLVANIA AVENUE, N.W., WASHINGTON, DC, 20004-2401, US

(21) Appl. No.: 09/859,427

(22) Filed: May 18, 2001

Related U.S. Application Data
(60) Provisional application No. 60/205,251, filed on May 19, 2000.

(51) Int. Cl. G06F 7/00

(52) U.S. Cl. 707/1

(57) ABSTRACT

A method and apparatus for providing customized information to a customer. The invention enables a provider to provide customized information in the form of summaries, analysis and stories, that has been determined to be useful to the customer. The customer may receive the customized information from the provider in a variety of ways, including via a customized information portal, an email, a facsimile, etc.

### RELATED APPLICATIONS

This application claims priority under 35 U.S.C. § 119 to provisional application No. 60/205,201, filed May 19, 2000, the entirety of which is incorporated herein by reference.

### BACKGROUND OF THE INVENTION

1. Field of the Invention

The present invention relates generally to providing customized information to an aggregation of users over a network.

2. Description of the Background Art

Services currently exist that provide information to an individual user based on preferences selected by that user. Thus, a news source with an on-line presence may enable users to select whether they want daily emails containing (1) general news headlines, (2) opinion headlines only, (3) technology news only, or (4) sports news only. Users are then sent daily emails corresponding to their choices. These systems work satisfactorily at the level of an individual interested in a single publication, although the broad categories used typically result in a user seeing many headlines in which he has no interest. The art does not provide for providing highly customized information from a city of sources to an aggregation of individuals joined by a common interest or affiliation, such as employment at a particular company. What is needed therefore is a system for determining information that an aggregation of individuals will have an interest in, and a method for providing such information to such an aggregation.

### OBJECTS OF THE INVENTION

The present invention provides customized information from a plurality of sources to an aggregation of individuals, based on their common affiliation. The following objects are achieved, by some, but not necessarily all, embodiments of the invention. The scope of the invention is as defined in any allowed claims, including all equivalents, and should not be limited by any of the following objects.

It is an object of an embodiment of the present invention to provide customized information to an aggregation of individuals.

It is an object of an embodiment of the present invention to provide a method for collecting and screening information of relevance to an aggregation of individuals.

It is an object of an embodiment of the present invention to provide a graphical user interface that an aggregation of users can use to access information that has been collected and screened for relevance to their common affiliation.

### SUMMARY OF THE INVENTION

In summary, the invention provides a method for providing customized information, comprising (1) obtaining survey data indicative of whether a category (which may be predefined) is a topic of interest to a user or an aggregation of users; and (2) based on the survey data, creating a template for a report for providing information to the user, or to such an aggregation of users. In one embodiment, the report template is in the form of an information portal on the World Wide Web. The invention may also comprise the steps of (1) receiving attribute data for a record residing on a data communications network; (2) storing the attribute data in a first data bank; (3) generating a reference in a second data bank based on the attribute data, where the reference indicates a predefined category to which the record relates; (4) retrieving the attribute data from the first data bank based on the predefined category and the reference; and (5) generating a report based on the survey data and the attribute data. Embodiments of the invention also include providing analyses of news items and other information by experts, where the users receive only those analyses that are appropriate for them, based on the survey results. The invention may also include providing users access to authors of items that the user has access to.

The invention also comprises an apparatus and an article of manufacture for carrying out the method. Other features and advantages of the invention will become apparent through the following detailed description, the drawings, and the appended claims.

### BRIEF DESCRIPTION OF THE DRAWINGS

The accompanying drawings, which are incorporated in and constitute part of the specification, illustrate preferred embodiments of the invention, and, together with the description, serve to explain the principles of the present invention. In the drawings, like reference numbers indicate identical or functionally similar elements. Additionally, the left-most digit(s) of a reference number identifies the drawing in which the reference number first appears.

FIG. 1 is a block diagram of a computer system as may be used to implement an embodiment of the invention.

FIG. 2 is a block diagram showing a method for providing the customized screen display of an embodiment of the invention.

FIG. 3 is a block diagram showing the interaction of the components of the system of an embodiment of the invention for providing an information portal for a customer.

FIG. 3(a) is a block diagram showing a customized information delivery system pursuant to an embodiment of the invention.

FIG. 4 shows an information portal pursuant to an embodiment of the invention.

FIG. 5 shows an example of a screen display used for providing a “summary story” of an embodiment of the invention.

FIG. 6 shows an example of a screen display of an embodiment of the invention for enabling a customer to email an item along with comments of the customer.

FIG. 7 shows an example of a screen display of an embodiment of the invention for communicating with the provider.

FIG. 8 shows an example of a screen display used for providing an “in depth analysis” of an embodiment of the invention.

FIG. 9 shows an example of a screen display of a webcast feature of an embodiment of the invention.

FIG. 10 shows an example of a screen display used for providing search capability and presenting search results of an embodiment of the invention.

FIG. 11 shows an example of a screen display used to implement a “profile” feature of an embodiment of the invention.

Definitions

“Aggregation of users,” “aggregation of individuals” or “aggregation” means a plurality of users or individuals joined by a common interest or affiliation. Typically, a survey will have been conducted on each member of the aggregation, or on a representative sample of the aggregation. An “aggregation of users” of the present invention is also referred to as a “customer.”

“Customer” refers to any aggregation of individuals for whom a provider provides access to a customized report or information portal, and can refer to a business or a group of businesses. A customer can also be a single individual, for whom a provider provides access to a customized report, where the content in the report has been selected based on a survey conducted on that individual.

“User” refers to an individual using the product of the invention.

“He,” “his,” “him,” mean “he or she,” “his or her,” and “him or her,” respectively.

“In-depth analysis,” “analysis story,” or “analysis” refers to an in-depth item written and researched by analysts and/or experts working for the provider, to be read by the customer.

“Information Portal” refers to a screen display that provides access to information from a multiplicity of sources. In an Internet embodiment of this invention, an information portal is a web page that provides information, as well as the opportunity for a user to click on various areas of the screen to view more information.

“Item” refers to a piece of information, such as an in-depth analysis, a summary story, or other news item accessible by a user of an embodiment of the invention.

“Provider” refers to the individual, organization, business, or other entity that provides the services described in this specification.

“Report” includes an electronic “information portal” that provides a user (or an aggregation of users) access to information from a variety of sources. A “report” can thus refer to the information portal itself, or the information portal plus the information that can be accessed from the information portal. A report can also comprise information that is emailed, faxed, mailed, or otherwise communicated to an individual.

“Summary” or “summary story” includes relatively short summaries of news items. In some embodiments, a “summary” includes a summary as well as a short analysis of the news item.

“Article of manufacture comprising an information storage medium encoded with a computer-readable data structure for use in connection with serving an information portal” includes, without limitation, a storage device of an ISP used to encode HTML, JAVA, or other code to provide a Web page as part of a Web site containing an information portal.

“Article of manufacture comprising a propagated signal, said signal having encoded therein machine-readable information comprising information related to an information portal for providing customized information” refers, without limitation, to an electronic signal transmitted over a telecommunications link for purposes of making available for viewing a web page containing such information. That a signal has information encoded therein should not be understood to preclude the signal from having other, further information encoded therein.

Detailed Description of Embodiments

Reference will now be made in detail to the preferred embodiments of the invention, examples of which are illustrated in the accompanying drawings. Notably, the present invention may be implemented using software, hardware or any combination thereof, as would be apparent to those of ordinary skill in the art, and the figures and examples below are not meant to limit the scope of the present invention or its embodiments or equivalents. For the purpose of explanation, numerous specific details, such as certain graphical user interface menus, and the like, are set forth. It will be apparent to one skilled in the art, however, that the present invention may be practiced without these specific details, and is not limited to the specific details shown and described. In other instances, structures and devices are shown in block diagram form to more clearly set forth the present invention.

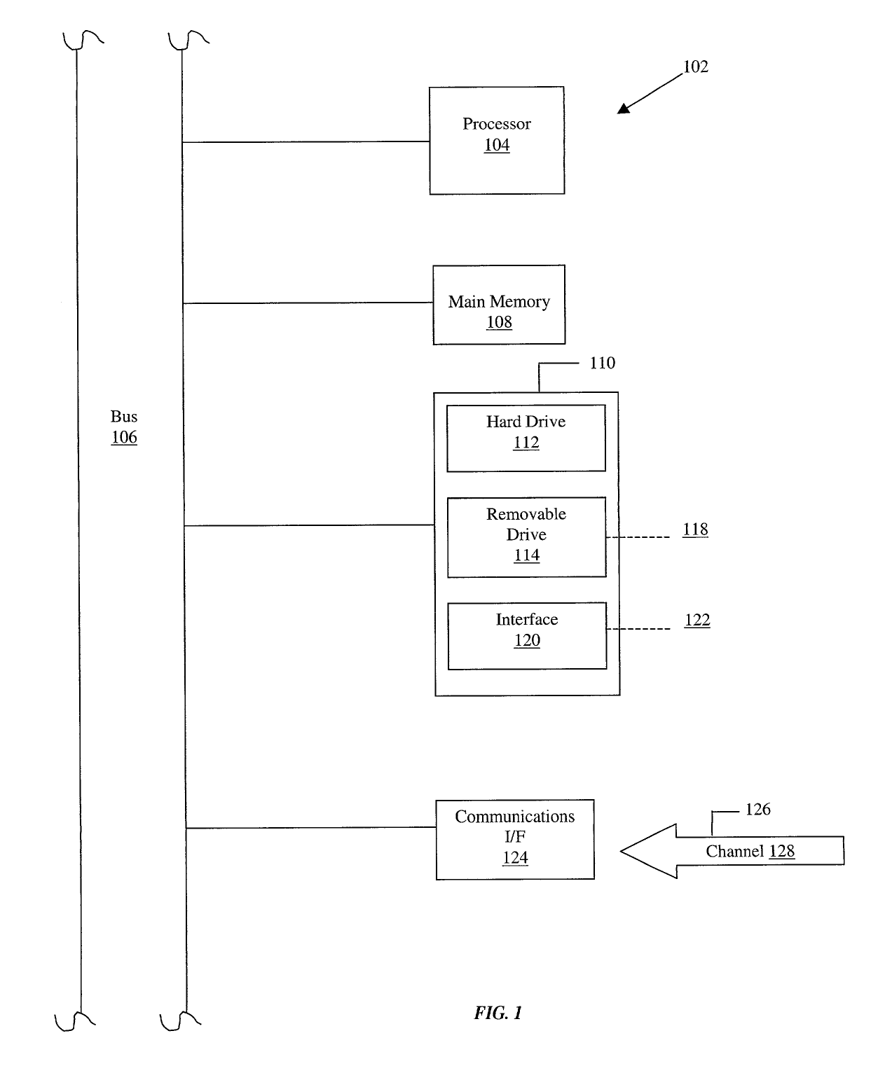

With reference now to FIG. 1, a description of a computer system suitable for use with an embodiment of the present invention is provided. The computer system 102 includes one or more processors, such as a processor 104. The processor 104 is connected to a communication bus 106. Various software embodiments are described in terms of this exemplary computer system. After reading this description, it will become apparent to a person skilled in the relevant art how to implement the invention using other computer systems and/or computer architectures.

The computer system 102 also includes a main memory 108, preferably random access memory (RAM), and can also include a secondary memory 110. The secondary memory 110 can include, for example, a hard disk drive 112 and/or a removable storage drive 114, representing a floppy disk drive, a magnetic tape drive, an optical disk drive, etc. The removable storage drive 114 reads from and/or writes to a removable storage unit 118 in a well-known manner. The removable storage unit 118, represents a floppy disk, magnetic tape, optical disk, etc. which is read by and written to by the removable storage drive 114. As will be appreciated, the removable storage unit 118 includes a computer usable storage medium having stored therein computer software and/or data.

In alternative embodiments, the secondary memory 110 may include other similar means for allowing computer programs or other instructions to be loaded into the computer system 102. Such means can include, for example, a removable storage unit 122 and an interface 120. Examples of such can include a program cartridge and cartridge interface (such as that found in video game devices), a removable memory chip (such as an EPROM, or PROM) and associated socket, and other removable storage units 122 and interfaces 120 which allow software and data to be transferred from the removable storage unit 122 to the computer system 102.

The computer system 102 can also include a communications interface 124. The communications interface 124 allows software and data to be transferred between the computer system 102 and external devices. Examples of the communications interface 124 can include a modem, a network interface (such as an Ethernet card), a communications port, a PCMCIA slot and card, etc. Software and data transferred via the communications interface 124 are in the form of signals 126 that can be electronic, electromagnetic, optical or other signals capable of being received by the communications interface 124. Signals 126 are provided to communications interface via a channel 128. A channel 128 carries signals 126 and can be implemented using wire or cable, fiber optics, a phone line, a cellular phone link, an RF link and other communications channels.

In this document, the terms “computer program medium” and “computer usable medium” are used to generally refer to media such as the removable storage device 118, a hard disk installed in hard disk drive 112, and signals 126. These computer program products are means for providing software to the computer system 102.

Computer programs (also called computer control logic) are stored in the main memory 108 and/or the secondary memory 110. Computer programs can also be received via the communications interface 124. Such computer programs, when executed, enable the computer system 102 to perform the features of the present invention as discussed herein. In particular, the computer programs, when executed, enable the processor 104 to perform the features of the present invention. Accordingly, such computer programs represent controllers of the computer system 102.

In an embodiment where the invention is implemented using software, the software may be stored in a computer program product and loaded into the computer system 102 using the removable storage drive 114, the hard drive 112 or the communications interface 124. The control logic (software), when executed by the processor 104, causes the processor 104 to perform the functions of the invention as described herein.

In another embodiment, the invention is implemented primarily in hardware using, for example, hardware components such as application specific integrated circuits (ASICs). Implementation of such a hardware state machine so as to perform the functions described herein will be apparent to persons skilled in the relevant art(s). In yet another embodiment, the invention is implemented using a combination of both hardware and software.

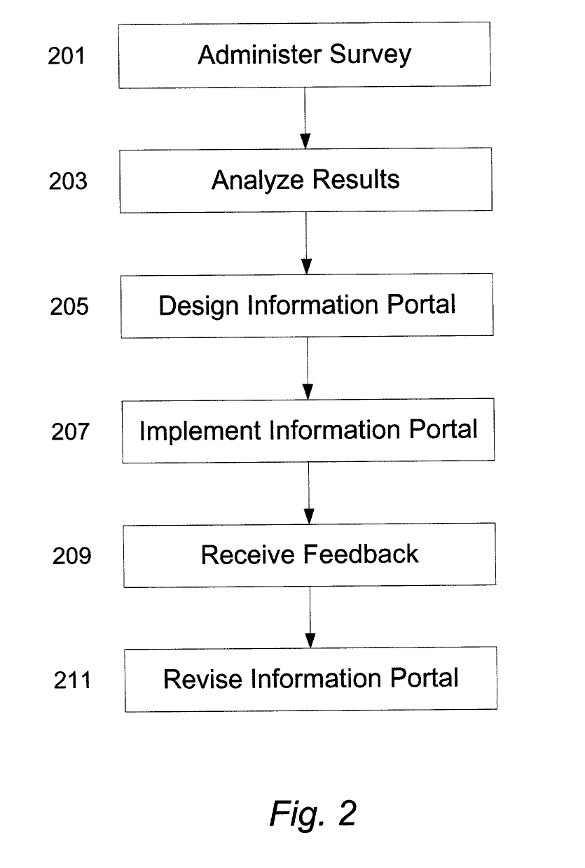

FIG. 2 is a flowchart depicting the creation of an information portal in accordance with an embodiment of the invention. In step 201, a survey is administered to a plurality of individuals with a common affiliation. Typically, the common affiliation will be a common employer, and FIG. 2 is hereinafter described from the perspective of a survey conducted among employees of a business, where the business is a customer of a provider (defined above), and the provider administers the survey. It will be recognized, however, that the invention is not necessarily limited to businesses, and indeed can be practiced where the customer is a single individual, regardless of whether that individual is involved in a business. Returning to step 201, the survey collects information upon which to base content selection for an information portal for the surveyed individuals, or for a larger aggregation of individuals of which the surveyed individuals are considered to be representative. The individuals chosen for the survey will typically be representative of a larger aggregation of individuals within the business, but in some embodiments, the individuals surveyed constitute the totality of the individuals who will be given access to the information portal.

In one embodiment, the survey comprises a form survey to be filled out in writing by the individual, either on paper or electronically. The survey may also comprise a telephone interview, or an in-person interview, in which the surveyor may or may not ask follow up questions. The survey can also be conducted by a computer system, with answers being entered on the computer screen. In one embodiment, the survey is conducted by an interactive computer program that is responsive to responses given by the individual, and thus might ask different questions, or follow-up questions, based on an individual's response to a given question.

The survey can comprise multiple choice questions, fill in the blanks, and open-ended questions. In one embodiment, the survey covers topics such as (1) what external and internal sources of information are used on a regular basis; (2) what is the perceived quality and usefulness of these information sources; (3) how is information shared within the company; (4) what are strategic goals of the company and what information and intelligence will be most useful to attain these goals; (5) what topics, competitors, regions, and trends are most important to follow.

In order to determine current sources of information, the survey can gather information on the use and usefulness of daily newspapers, journals, industry papers, other publications, the company's intranet, other Internet sources, and other sources, such as consulting groups. In order to further determine what information is needed, the survey can probe areas such as the need for information about competitors, customers, regions of particular interest, industry developments, technology trends, management trends, economic trends, geopolitical trends, and regulatory trends. In the case where the initial survey does not comprise a personal interview, personal interviews of some or all survey participants can be used to refine the results of the survey.

In step 203, the results of the survey are analyzed. While it is within the scope of the invention to analyze the survey results using a computer program, based on the current state of the art of artificial intelligence, significant advantages are achieved when a human being analyzes the survey results. Thus, a human analyst can better deal with information contained in answers to open-ended questions, and, in interviews, can ask follow-up questions that might lead to insights that could not be gained by a computer. Analyze survey results step 203 can comprise (1) generating a list of follow-up questions, (2) assessing the need for additional participants in the survey, and (3) generating a document reporting the results of the survey.

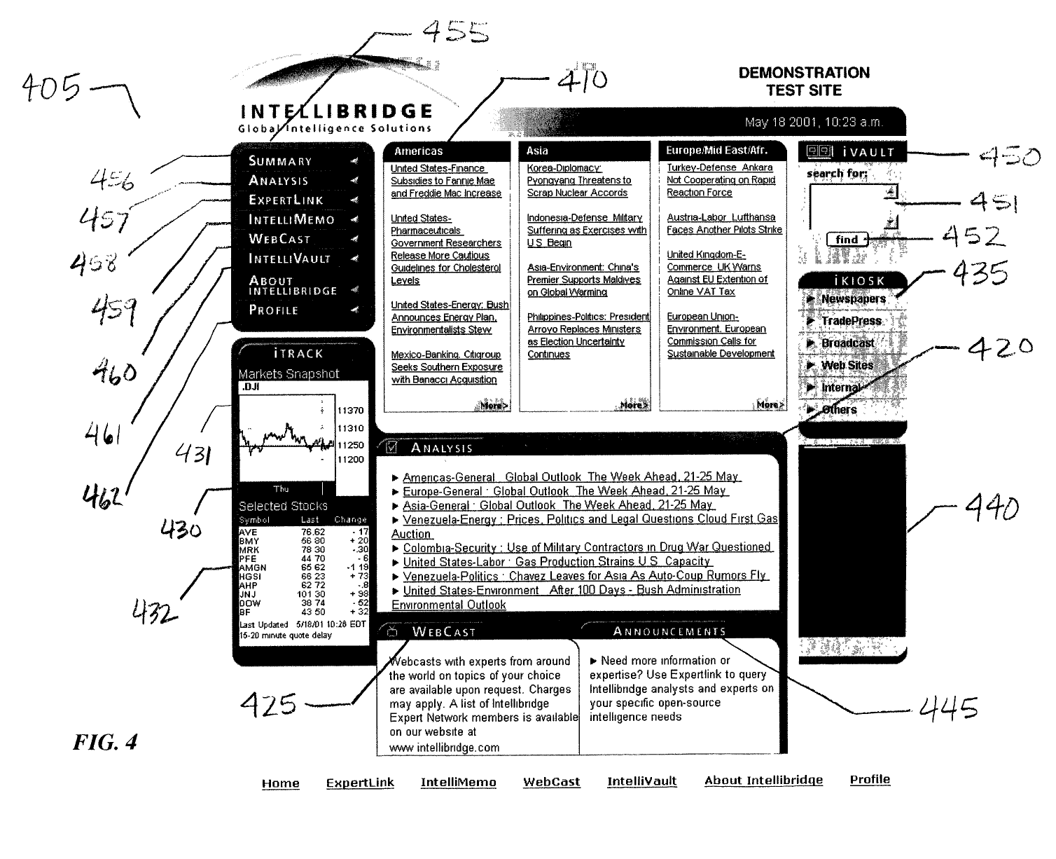

In step 205, content for an information portal is selected based on the analysis of the survey results. This step can be accomplished by the same individual or individuals who analyzed the survey results in step 203, or it can be accomplished by a different individual or group of individuals. Alternatively, this step could be accomplished by means of a computer program. The selection of content will thus be tailored to the content needs of the client, as reflected in the survey (which was designed to ascertain the client's content needs). An exemplary display screen for an information portal of an embodiment of the invention is depicted in and discussed in connection with FIG. 4, below.

The embodiment depicted in FIG. 2 contains the further step 207 of implementing a prototype information portal based on the content selection arrived at in step 205, although this step is not essential to the invention. The prototype information portal can be made available to one or a plurality of users, and feedback from these users (step 209) can result in revisions being made to the information portal (step 211).

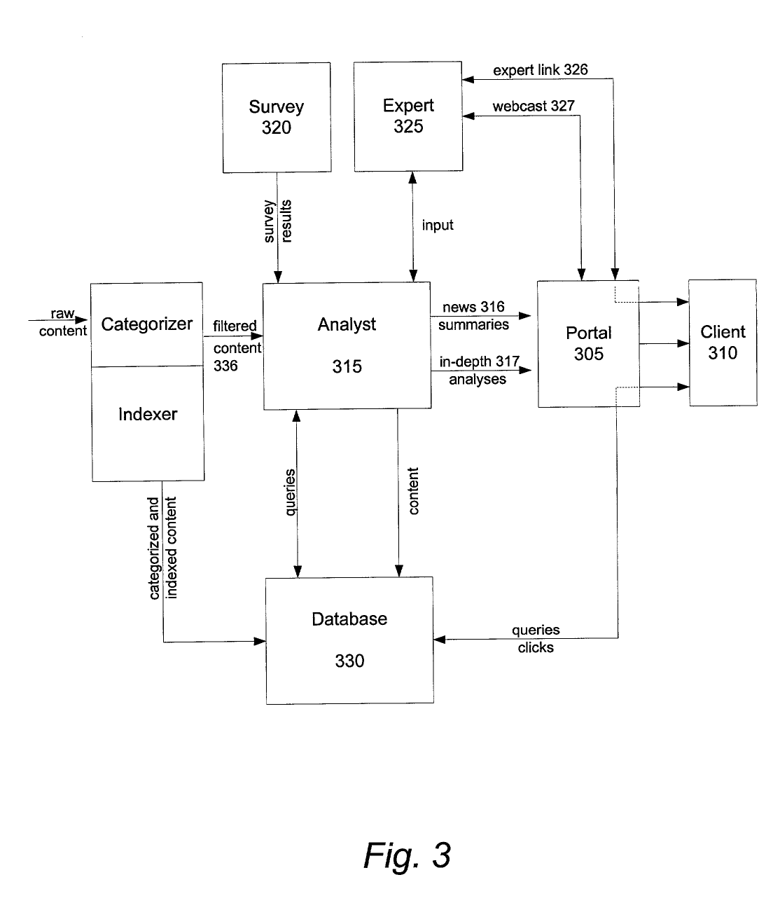

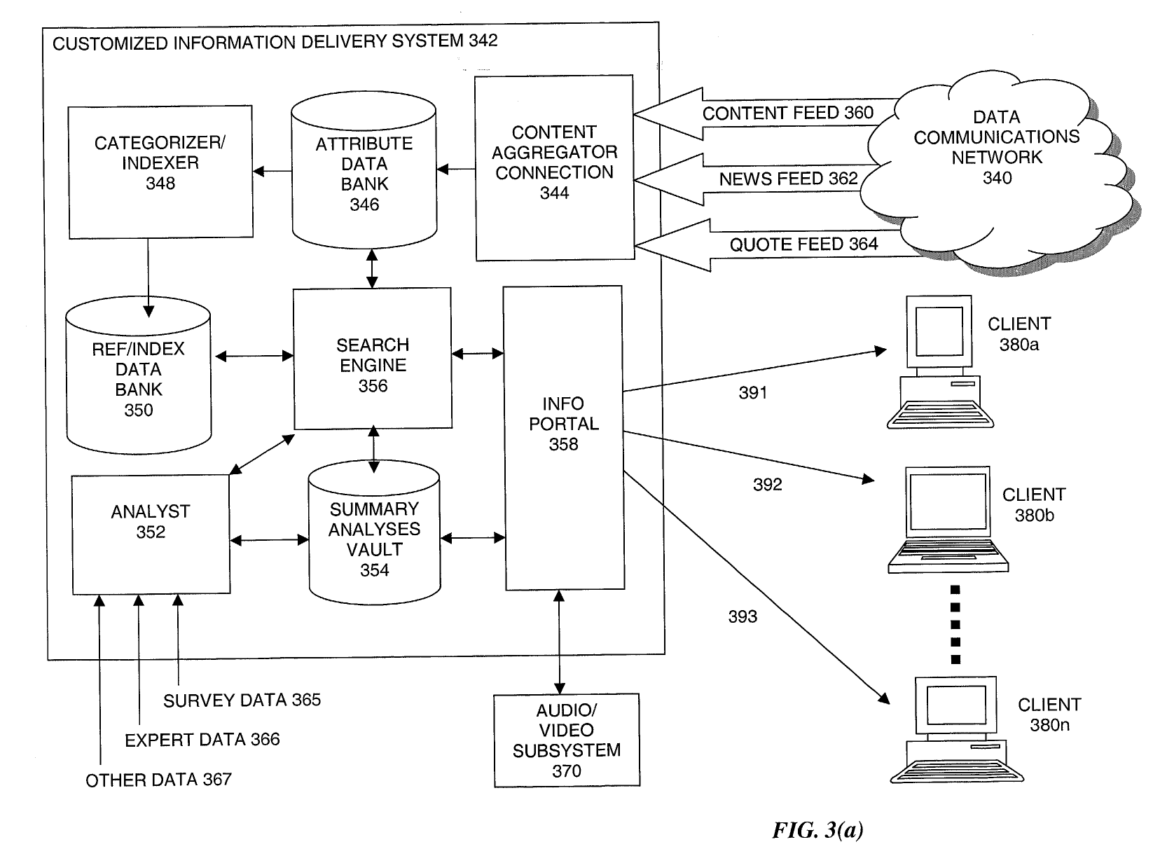

FIG. 3 is a block diagram of the components that operate to provide information to an end user through an information portal of an embodiment of the invention. In the embodiment depicted in FIG. 3, information portal 305 receives information from a plurality of sources as input, and provides an output—the information portal—to a customer 310. In some embodiments, some or all data, including video data, transmitted as part of the information portal system is encrypted for increased security. In some embodiments, performance of a web-site embodiment of the invention is enhanced by using caching appliances or Internet acceleration providers, as is known to those with ordinary skill in the relevant arts.

FIG. 4, discussed below, presents a depiction of an information portal screen pursuant to an embodiment of the current invention. In other embodiments of the invention, the user can access the content of the information portal by telephone or mobile phone (in which case the content may be provided in audio format, for example through use of a computer-generated voice, clipped video format, or both), or other mobile devices such as personal digital assistants (PDAs) or pagers.

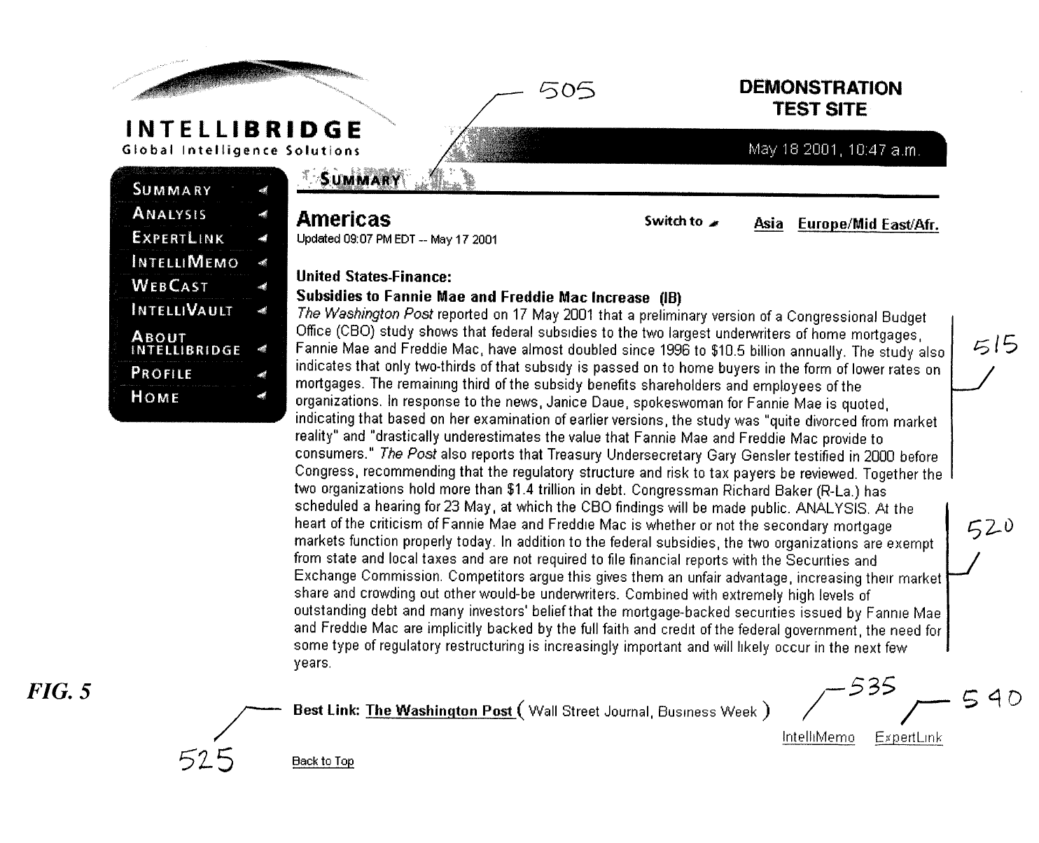

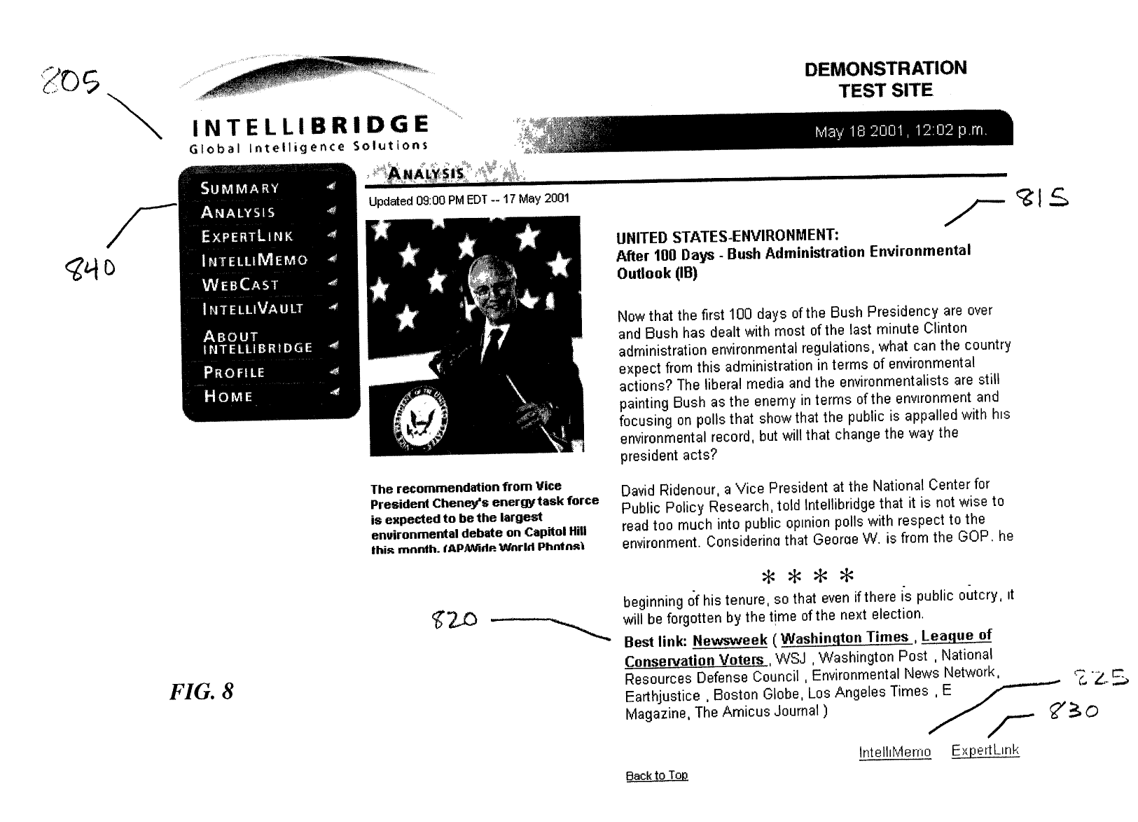

In the depicted embodiment, information portal 305 receives as input from analyst 315 news summaries 316 and customized analyses 317. New summaries 316 are discussed in more detail in connection with FIGS. 4 and 5, and customized analyses 317 are described in more detail in connection with FIGS. 4 and 8.

The portal is typically provided by an application service provider model, but also can be provided in whole or in part by software and hardware installed internally within a customer 310's IT system.

In some embodiments, a particular company may be subdivided into several different “customers,” where each customer represents a different user community in the company. For example, a company may have a junior management and a senior management section, wherein each entity had its own portal. In some embodiments, an end-user, in some cases a privileged end user, of a such a company has the ability to select which of the company's sites to use as an information portal for a particular session.

In some embodiments, users associated with customer 310 have the ability to add to and/or edit the content that the provider writes in a collaborative environment. In some embodiments, third parties working on behalf of the customer—such as attorneys, accountants, and consultants—also have access as well as adding and editing privileges, and thus can provide their particular take on the content provided by the provider. In these embodiments, the customer's preexisting professional relationships are seamlessly integrated with the information portal service.

In some embodiments, individuals within the customer have the ability to track and obtain the history of the movements of other customer users within the information portal over time, including what searches were done, and any interactions with experts. Thus, for example, a supervisor will have ready access to information regarding which of his subordinates has accessed (and presumably read) a particular item on the information portal, or which subordinate has dealt with a particular expert, or which of his subordinates can be expected to have the most expertise in a particular subject area, based on the subordinates' viewing histories.

Analyst 315 can comprise a single individual or a group of individuals, and the identities of the individual or individuals can vary over time. In one embodiment, analyst 315 is an expert or specialist in at least one subject matter area. Typically, analyst 315 has access to—and thus receives input from—survey 320, as described in connection with FIG. 2. In some embodiments, analyst 315 participated in the data collection and/or analysis of the survey. In such embodiments, because of his familiarity with the survey, analyst 315 is aware of what content is of interest to the customer, and thus can provide new summaries 316 and analyses thereof, as well as longer analyses 317, that are likely to be of utility to the user.

In one embodiment, a summary or analysis written by analyst 315 contains an email link to analyst 315, such that a user reading an item from information portal 305 can rapidly establish e-mail contact with the author of the item, in order to ask questions or make comments on the item.

In some embodiments, analyst 315 is specifically associated with customer 310 such that his output only goes to the information portal 305 serving customer 310. In other embodiments, the analyst's work product can be fed to information portals serving other customers (not depicted).

As input, analyst 315 can receive information from expert 325. Expert 325 is a person with expertise in at least one subject matter area. In some embodiments, analyst 315 has access to a plurality of experts, such that the subject matter expertise of the experts covers a substantial amount of the subject matter to be presented to the customer.

In some embodiments, expert 325 is available to help analyst 315 analyze news in the process of creating summaries or analyses. In some embodiments, expert 325 and analyst 315 can be the same person, or in any event expert 325 might be primarily responsible for generating more detailed analyses, such as in-depth analyses 317.

Expert 325 can also be available to customer 310 by means of a direct email link (expert link 326), as depicted in and discussed in more detail in connection with FIG. 8. In addition, the expert in one embodiment plays a role in a webcast 327—as for example speaker, moderator, interviewer, or interviewee—that is accessible to the customer 310 through information portal 305.

Returning to analyst 315, analyst 315 can interact with database 330. Database 330 contains or contains links to past and present news summaries 316, in-depth analyses 317, webcasts, and key source articles, as well as learning modules. In some embodiments, for some items, database 330 contains attribute information—such as the title of the item, the category or categories in which the item falls, a network addressable location for the item, the name of the author of the item, the name of the publisher of the item, and/or the date of the item, rather than the item itself.

Database 330 can be a single database containing data that was generated for a plurality of customers, with each customer's access to the data defined by contract. Typically, the contract will provide for database access to data that the customer had access to when it was posted in a daily posting on the information portal.

In one embodiment, some of the items in database 330 come from the Internet, by means of categorizer/indexer 335, without any human intervention. Other sources of material for database 330 are all information available through the information portal, including webcasts 327, news summaries 316, in-depth analyses 317, or the customer's intranet (not depicted).

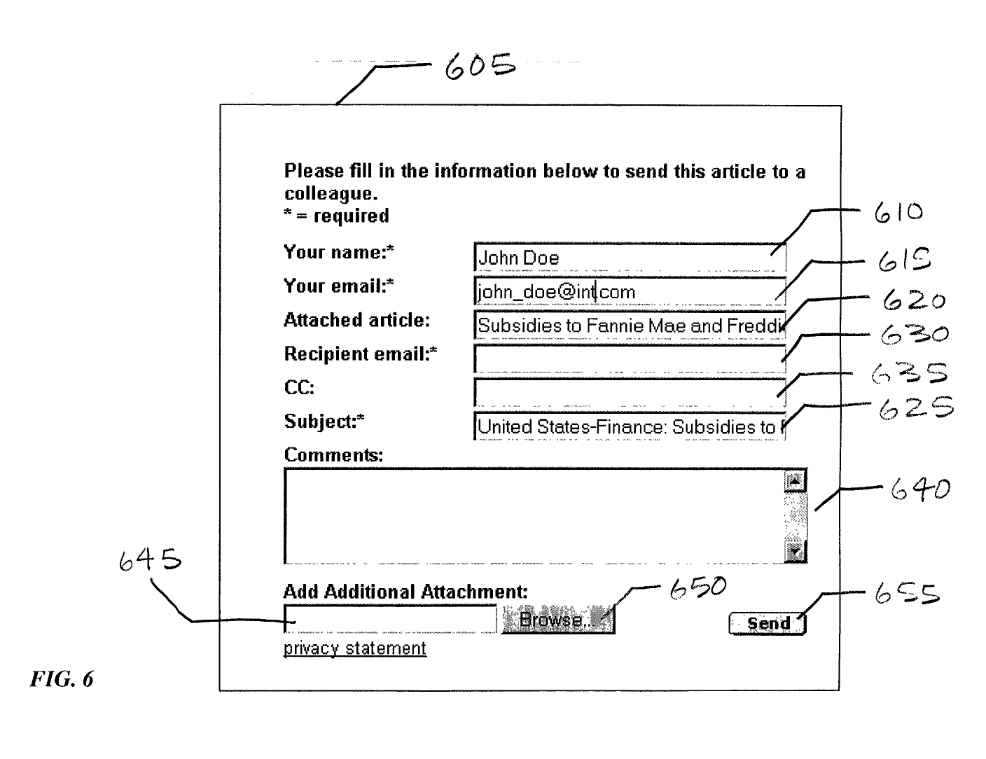

Database 330 can be queried by analyst 315 or expert 325 or any other individual on the provider-side of information portal 305, as well as by customer 310 through information portal 305, as described in more detail in connection with FIG. 6.

Returning to analyst 315, analyst 315 also receives “filtered content” input from categorizer/indexer 335, which takes raw news and other content records, which may be obtained from news and content sources that the provider has a relationship with, or by the use of spiders, as is known in the art—and assigns one or more category to each one, and indexes them.

Thus, the output of categorizer/indexer 335 can be considered “filtered” and can be viewed by the analyst by category. In addition, the output of categorizer/indexer 335 may go into database 330 or one or more auxiliary databases (not depicted). The output may either be the content record itself, one or more attributes of the content record, or the category/index entry.

The analyst is not limited to the inputs depicted in FIG. 3 and indeed may have a variety of inputs, such as information that he acquires as a result of working in a particular field or in the course of daily living (e.g. in print newspapers, or in seminars, or in conversations with colleagues). He may also acquire information through news feeds, unfiltered Internet searches, and Internet notification services. He may also bring to bear his own memory and experiences.

Analyst 315 may also receive information from the customer's intranet, and can use such information for preparation of summaries and in-depth analyses. Such information can also be made directly available to the customer through the information portal, as discussed (for example) in connection with FIG. 4, area 432.

FIG. 3(a) shows a block diagram of a preferred embodiment of a customized information delivery system 342 according to the present invention. As illustrated in FIG. 3(a), the system comprises a content aggregator connection 344, an attribute data bank 346, a categorizer/indexer 348, a reference/index data bank 350, a search engine 356, an analyst 352, a summary and analyses vault 354 and an information portal 358. The system may optionally include an audio/video subsystem, depicted in FIG. 3(a) with reference number 370.

In a preferred embodiment, the system receives attribute data for a record residing on data communications network 340, such as the Internet, via content aggregator connection 344 and one or more feeds, which are depicted in FIG. 3(a) as content feed 360, news feed 362 and quote feed 364. For some embodiments, attribute data may consist of a variety of details and/or properties about the record, including but not limited to, its contents, its network addressable location, its age, its author or source, its publisher, its links to other records, or all of the above. For other embodiments, the attribute data may consist merely of a copy of the record's contents.

The content aggregator connection 344 is configured in the preferred embodiment to receive the attribute data in a variety of ways. One such way, called “spidering,” involves coupling content aggregator connection 344 to a web crawler. A web crawler is a program that visits web sites and reads their pages and other information in order to create entries for a search engine index. The major search engines on the web typically use such a program, which is also known as a “spider” or a “bot.” In this case, however, the web crawler is configured to scan web sites to find records on the data communications network 340 containing content that can be used by an analyst to develop stories relevant to the particular business interests of the customized information provider's clients. Preferably, an analyst familiar with the content needs of the provider's clients configures the web crawler to search for and retrieve the most appropriate records.

In a preferred embodiment, each spider process produces an index (IDX) file for each fetch “job” (e.g., each unique path within a website). Because the content data is voluminous and is constantly being updated, large amounts of memory are typically required. To help ameliorate this problem, the IDX files may be overwritten on subsequent fetch operations. The IDX files are parsed to retrieve the uniform resource locators (URLs) and other metadata that is necessary to populate a database, depicted as attribute data bank 346 in FIG. 3(a). In a preferred embodiment, the content body of the file is typically, but not necessarily, stripped out and stored in a separate data bank. The stripped out content data will ordinarily be retrieved later by the categorizer/indexer 348, as discussed below.

Another method for receiving record attribute data involves coupling content aggregator connection 344 to a third-party streaming content provider, such as Factiva™ or Screaming Media,™ in order to receive continuous streams of content data. As the attribute data is received, it is stored in files residing, for example, in attribute data bank 346 on customized information delivery system 342. Preferably, these files are formatted in extensible markup language (XML) for easy parsing, and are processed frequently by the content aggregator connection 344, so that the information contained in them can be made available to analyst 352 for the purpose of developing stories.

The categorizer/indexer 348 receives attribute data from the attribute data bank and categorizes and indexes incoming attribute data to facilitate conceptual and keyword searches by search engine 356. The category and index information is then placed into reference/index data bank 350. One step, although not necessarily the first step, in categorization is to define the types of categories available and the values that can be assigned to those category types. Defined category types might include, for example, Sector, Topic, Region, Company and People, and the values for these category types might include, telecommunications, USA, Motorola, etc. Once these category types and values are defined, they can be inserted into the reference/index data bank 350.

The attribute data is indexed and associated with category types and values by categorizer/indexer 348 as it is retrieved from the data communications network 340. In a preferred embodiment, an artificial neural network processor or natural language processor, trained and tested according to methods known by those of skill in the art, is utilized to assign records to the proper categories or to provide the proper indexes. For conceptual categories (e.g., Sector, Topic) proper training and testing documents are produced. For keyword categories (e.g., Region, Country, Company, and People), individual text files containing keywords separated by commas are produced. In a preferred embodiment, the attribute data is associated with a multiplicity of categories (to account for the situation where a record should be associated with more than one category).

As would be apparent to one skilled in the art, the process of using an artificial neural network (“ANN”) to solve problems involves two distinct phases: the training phase and operational phase. The training phase comprises the activities of: (1) building a “training set” for the ANN based on a representative sample and “correct” results as defined by a human trainer; and (2) repeatedly exposing the training set samples to the ANN along with the correct results for each sample until the ANN has “learned” how to derive the correct result for each sample on its own. In reality, the ANN does not actually “learn” how to derive the correct result, but generates an internal set of mathematical rules, which, when applied to the sample inputs, yields substantially the same results reached by the human trainer for each of the sample inputs.

At the end of the training phase, the ANN is considered to be “trained,” which means it should be capable of solving similar, but new problems. The operational phase comprises exposing the “trained” ANN to new objects (in this case, records residing on data communications network 340, or the contents of such records) that are similar, but not identical to those in the training set, and allowing the neural network to “decide” whether the new objects meet the criteria defined by its internal rules. There are a number of commercially available ANNs, suitable for purposes of categorizing and indexing records in accordance with the present invention. The ANN known and manufactured and sold by Autonomy™ , for example, more than adequately performs the job described herein.

In a preferred embodiment, categorizer/indexer 348 generates references and indexes that are stored in the reference/index data bank 350. Analyst 352, using survey data 365, expert data 366 and other data 367 (as more fully described above with reference to FIGS. 1 and 2), may generate and execute searches of reference/index data bank 350 via search engine 356. Analyst 352 then uses the indexes and references retrieved from reference/index data bank 350 to develop summaries and analyses, which are then stored in summary/analyses vault 354 or transmitted via information portal 358 and links 391, 392 and 393 to one or more clients operating on terminals 380a through 380n.

For illustrative purposes, FIG. 3(a) shows data being stored in three separate data banks (attribute data bank 346, reference/index data bank 350 and summary and analyses data bank 354). It will be appreciated by one of skill in the art, however, that the invention could be implemented by storing all data in a single data bank, or any number of data banks, without departing from the scope of the invention.

FIGS. 4-11 show examples of screen displays used in some embodiments of the present invention. Upon reading the descriptions of these screen displays, it will be readily understood that different screen locations, different heading names, as well as a myriad of other differences are possible, but that such changes do not necessarily depart from the spirit of the invention. In addition, the embodiment depicted and described uses a computer mouse to “click” to select various options. It will be understood that means of selecting links other than mouse clicking can be used to practice the invention.

FIG. 4 shows an example of a screen display for an information portal such as may be presented to an aggregation of users pursuant to an embodiment of the present invention. Although FIG. 4 depicts an information portal as may be seen on an Internet embodiment of the invention, it is important to understand that the invention need not be practiced on the Internet, and that the format for presenting the content generated by the invention can vary significantly from that depicted in FIG. 4. For example, the content generated by the invention, and described herein, can be published to a company's internal information distribution system, such as an intranet.

In one embodiment of the invention, the user is a member of an aggregation of individuals, such as a group of executives within a business or business enterprise, for whom a survey has been conducted to determine the sort of content that will assist individuals in the aggregation in doing their jobs. The survey is discussed at greater length in connection with FIG. 2, above. In one embodiment, such a user is sent at least one email every day (or every weekday) containing a link to a site containing an information portal containing content that is updated at least once a day. Typically, the user can also access the report directly on the Internet, either by entering a specific URL for the report on his browser bar, or by entering a URL for a site which will in turn provide access to the information portal. In one embodiment, the user is required to enter his name and a password in order to access the information portal.

The depicted embodiment, in field 410, prominently presents regional news headlines for three regions that have been determined to be of primary interest to the aggregation of users to whom the page is served pursuant to the survey procedure described in connection with FIG. 2. Clicking on a news headline calls up a screen, such as that depicted in FIG. 5, on which a summary story designated by that headline appears. As discussed in connection with FIG. 3, the summary stories are written by analysts, based on current news items. In the embodiment depicted in FIG. 5, the summary story is categorized both by region and by subject matter. Thus, the first story on FIG. 5 is categorized by Region “United States” and subject matter “Security,” as shown by header 505. These categories can be selected by the author of the summary from a set of categories—including topics, companies, and individuals—that have been preselected by the customer as being of primary importance.

In some embodiments, various parameters related to the quantity, content, and delivery of summaries are standardized for a given customer, or even for all customers. For example, a provider can specify that approximately 15-18 summary stories will be provided for each region per day, where each summary story is approximately 15-25 lines long, and each summary story is divided approximately equally between summary and analysis (as depicted on FIG. 5), and that subject matter is approximately 50 percent macro economic and general political/security/social information and 50 percent sectoral and company-specific information. In some embodiments, the summaries may contain specific text explaining how the information contained in the summary is relevant to the customer.

In addition, the provider can warrant that the summary stories for a given region will come out within a set period of time, for example 4 hours, after close of business in that region. For late-breaking stories of exceptional interest, in some embodiments, a “flash report” feature provides summaries that can be posted before (or after) summaries for the rest of the region. In some embodiments, a customer's users receive an email reporting when a summary set for a given region and/or when a “flash report” has been posted on the information portal. Such emails typically, although not necessarily, provide a link to the information portal.

In the exemplary display screen depicted in FIG. 5, each summary story may have an image (not shown)—which may be a map, a graphic or a photo—associated with it. In this embodiment, the summary story is divided into two parts, one part (515) comprising a summary of a news item, and another part (520) comprising a summary analysis of the news item. In a preferred embodiment the summary and the analysis of the summary story are of approximately equal length. In one embodiment, the summary and the summary analysis are written specifically for one customer, and are tailored to that customer's needs.

Link 525, labeled “Best Link” provides access to a story from a third-party content provider, which may be the story that formed the basis for the summary. In the case that for some reason the story that formed the basis for the summary is not available to be used with the information portal (as, for example, if the author of the story refuses to provide the provider a license to publish the story), then link 525 can provide the user access to a “critique” of the original source, which contains the uncopyrightable elements of the story and thereby conveys to the user the information conveyed by the original story. The critique may also contain copyrighted expression from the original story to the extent allowed by applicable provisions of the copyright laws, such as the “fair use” provisions of United States copyright laws.

A link may appear in any summary story for which an in-depth analysis has been prepared by the provider. If an in-depth analysis is being prepared but is not yet available, the display screen provides an indication of when the analysis will be available. In-depth analyses are discussed further in connection with FIG. 8.

Link 535, labeled “Intellimemo” on FIG. 5, provides access to an emailing screen such as that depicted in FIG. 6. In FIG. 6, emailing screen 605 enables a user to email a summary article to a colleague. In the embodiment depicted in FIG. 6, fields for the user's name (610) and email address (615) and the title (620) and subject (625) of the attached article are already filled in by the computer system. The user fills in the email address of the intended recipient in field 630, and then has the option of (1) sending a copy to another recipient (635), (2) adding a comment in field 640, and/or (3) adding an additional attachment in field 645 (which can be located on the user's system by means of browse button 650). In this embodiment, clicking send button 655 to send the article to a colleague.

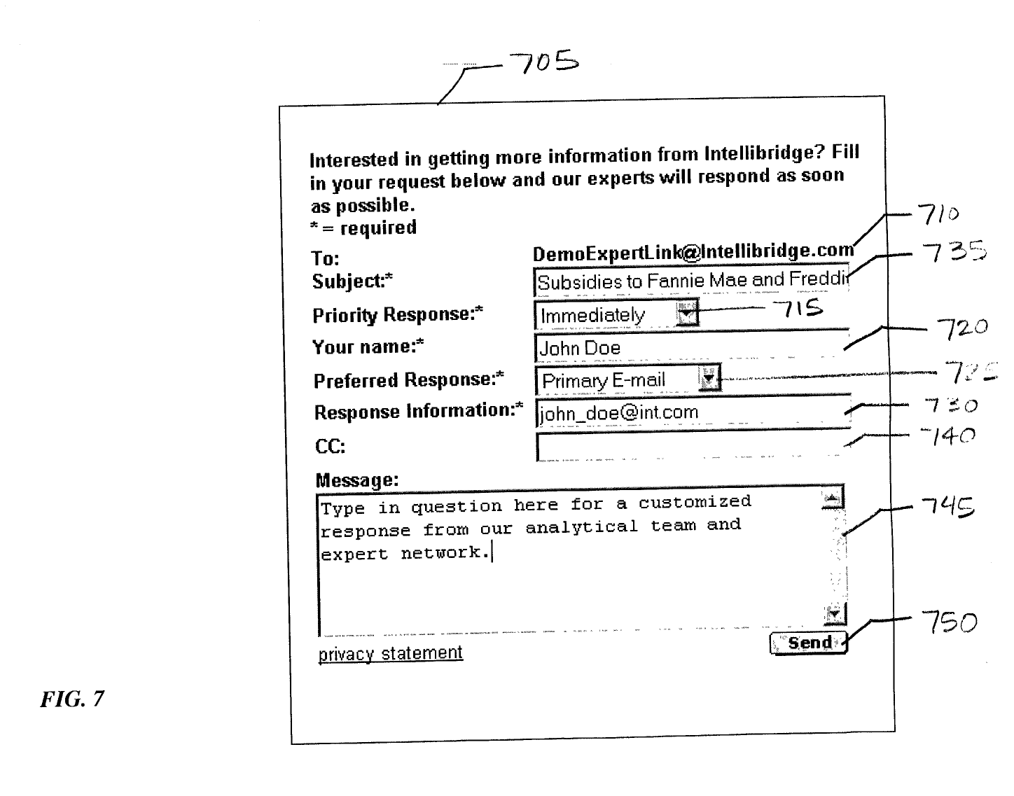

Returning to FIG. 5, clicking the link labeled “ExpertLink” 540 calls up an emailing screen, such as that depicted in FIG. 7, which provides email access to the author of the summary. Screen 705 is called up whenever the user clicks the “ExpertLink” button (which may appear in connection with an item, or may appear on the information portal screen without necessarily being associated with an item). In the embodiment depicted in FIG. 7, fields for the expert's email address (710), priority of response (715), user's name (720), user's preferred response (725), and user's email address (730) are automatically filled in by the computer system. As depicted in FIG. 7, fields 715 and 730 have browsing arrows associated with them for selecting, respectively, a different priority of response (such as “Normal”) or a different preferred mode of response (such as “telephone”). In some embodiments, when the expert emailing screen has been reached after viewing an item, such as a summary or an in-depth analysis, field 735 (“Subject”) is filled in automatically with the title of the item. Field 740 provides the option of sending a copy of the email to another party. In field 745, the user types in a question or comment for the expert. The user sends the email by clicking on a send button 750.

Returning to FIG. 5, the summary screen may contain other links not depicted in FIG. 5, such as links to audio files, video files, or in-depth analyses associated with the summary. Links to audio and video files typically, although not necessarily, comprise graphical icons. In addition, the summary screen may contain a link or tab providing access to a discussion forum or bulletin board that can be used by users, analysts, and/or experts to discuss a particular summary with other users, analysts, and/or experts. In some embodiments, the summary screen itself indicates whether a discussion about a particular summary has been initiated.

Returning to FIG. 4, headlines of in-depth analyses are displayed in field 420. In this embodiment, clicking on a headline calls up an analysis screen such as the example depicted in FIG. 8 (where the asterisks in the center of the screen denote material omitted for purposes of fitting the screen on one page for purposes of illustration).

With the exception of the longer content, the analysis screen is very similar to the summary screen. Header 815 provides regional and subject matter categorization. The analysis may have an image (not depicted) associated with it. Link 820, labeled “Best Link,” provides access to a story from a third-party content provider, which may be the story that prompted the analysis. Link 825 provides the ability to send the analysis to a colleague, as already described for summaries in connection with FIG. 6. Link 830 enables the user to send an email to the expert or analyst who wrote the analysis, as described for summaries in connection with FIG. 7.

Screen 805 depicts an optional navigation bar 840, which provides easy access to other features of the invention. The navigation bar, which in some embodiments appears on many of the screens of the invention, is described in more detail in connection with FIG. 4 (navigation bar 455), below.

The analyses are in-depth stories, written by the experts and analysts of the provider, that in some embodiments are published exclusively for each client as they pertain to their businesses. In such embodiments, these analyses (1) feature exclusive access to world subject matter experts, (2) provide company and individual personalization of news, (3) provide high-end analysis, and (4) populate a database (such as database 330 of FIG. 3) of high value content for a customer on an ongoing basis. In some embodiments, some analyses are generic and thus suitable for a plurality of customers without editing. In other embodiments, even potentially generic analyses are screened, and if necessary, edited, by the provider to ensure that the overall product received by the customer remains suitably customized.

In some embodiments, various parameters related to the quantity, content, and delivery of in-depth analyses are standardized for a given customer, or even for all customers. For example, a provider can specify that approximately 4-6 in-depth analyses will be provided for each region for each day, where each in-depth analysis is approximately 300-500 words long. In some embodiments, the in-depth analyses contain specific text explaining how the information contained in the in-depth analysis is relevant to the customer.

In some embodiments, the analysis screen contains a link or tab providing access to a discussion forum or bulletin board that can be used by users, analysts, and/or experts to discuss a particular in-depth analysis with other users, analysts, and/or experts. In some embodiments, the analysis screen itself provides an indication to the user as to whether a discussion concerning a particular in-depth analysis has been initiated.

Returning to FIG. 4, webcast field 425 provides information about upcoming webcast events to be held by the provider, as well as information about how a user can set up a webcast event. Clicking the webcast tab provides access to webcasts for which the user is authorized access. In a preferred embodiment, webcasts are run in real-time, and users can participate, either by typing questions or comments onto their computers, or by speaking into microphones connected to their computers.

The audio and video quality of webcasts and other streamed events as seen by users can be maximized by selecting an Internet Service Provider (ISP) for the participants in the webcast that is as close in proximity to the provider's ISP on the Internet backbone as possible. Thus, proper selection of an ISP for the expert can minimize the number of nodes over which the webcast must travel in order to reach the provider, and thus maximize webcast quality. In some embodiments, the provider maps out the locations of ISP's on the Internet relative to the location of the provider's datacenter or datacenters in order to determine ISPs that provide good performance for their end users connecting to the provider. Based on such a map, the provider can recommend the optimal ISP for an expert and/or a customer. In some embodiments, the provider provides such preferred-ISP Internet access to the expert for free.

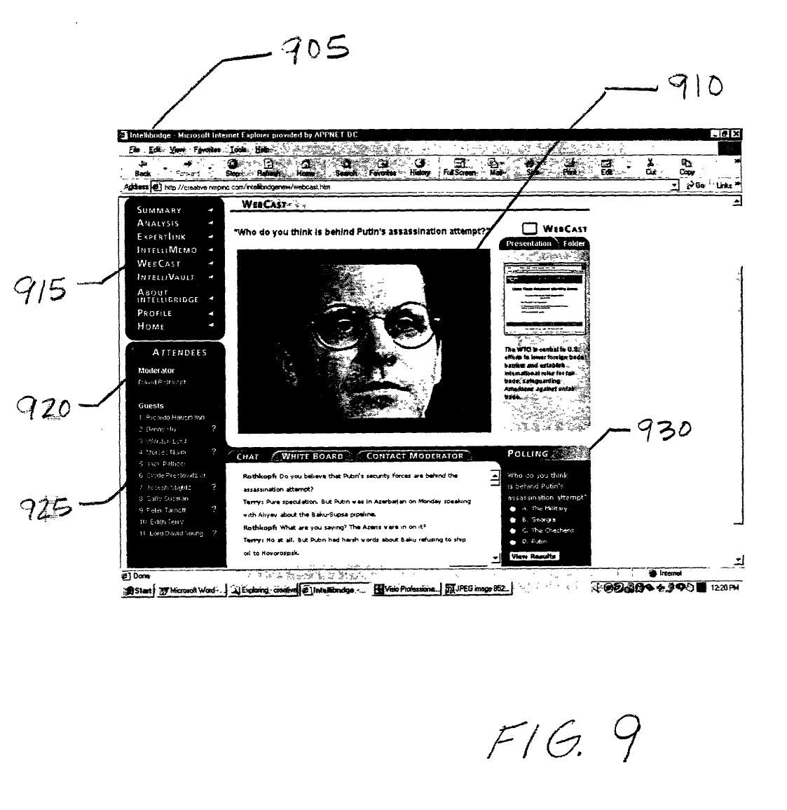

An exemplary webcast screen is depicted in FIG. 9. Webcast screen 905 contains the video display of the webcast in the center of the screen. On the periphery of the screen are navigation bar 915, list of attendees 920, area 925, and polling box 930. Area 925 can be used for a chat room, a whiteboard, or to contact the moderator, by selecting the appropriate tab at the top of area 925. Polling box 930 enables the user to cast a “vote” in one or more polls related to the webcast.

The webcast screen can be used to provide several different kinds of products to the customer. Content for such streaming applications can be produced by the provider for one or more of its customers, or can include video clips produced by third parties. Thus, for example, prerecorded, preprogrammed multimedia background briefings on individual countries and sectors of special interest may be offered. In addition, live or prerecorded teaching webcasts can be provided for continuing education purposes. In addition to such learning modules, webcasts can feature selected outside experts, consultants, and guests for commentary on current and breaking news, in a format that enables audience members to participate in the discussion. In addition, webcasts can include regularly-scheduled discussion groups comprising users with common interests, and experts who can address those interests. In interactive webcasts, participants can pose questions and make comments from their keyboards, from microphones attached to their PCs, via the telephone, or via other means, including 2n-way video conferencing. In addition, in some embodiments, users can access webcast or other audio-including content by telephone, such that users need not be at their computer terminals to participate in a webcast.

In some embodiments, mobile satellite video conferencing technology is used to extend the reach of the webcasts such that they are available anywhere and anytime. In some embodiments, the performance of the provider's video technology is enhanced by installing video relay devices in or near customer sites.

Webcasts, either from the webcast screen or from a window on the information portal screen, can also comprise newscasts, where one or more newscasters or a computer-generated voice reads the summary stories and analyses, much like a traditional newscast. Such newscasts can be implemented using streaming video or broadcast technologies.

Webcasts may be stored in the database, for later retrieval in response to queries. In some embodiments, transcripts are prepared using voice-recognition software to allow for search responses based on the entire text of the webcast.

Returning to FIG. 4, market information area 430 enables the user to view preselected, up-to-date market information. Typically, this information comes from a third party provider. One third-party source of market information is Factiva, a Dow Jones & Reuters company. In the embodiment depicted in FIG. 4, the user is provided with market snapshot field 431 and selected stock quotes 432.

Market snapshot field 431 provides charts of financial market performance data. The precise charts provided may be specific to each customer, based on the survey results and ongoing feedback between the customer and the provider. Market snapshot field 431 may contain multiple, different charts, which are automatically scrolled through by the computer system. The snapshots are refreshed often, in accordance with the capabilities of the web-site and the third party provider. In some embodiments, an individual user may specify which market charts he wants to see.

Area 432 enables the user to view quotes of customer and competitor company stock, futures quotes, commodity prices, foreign exchange quotes, as well as internal customer data such as sales volume. In the case of internal customer data, the information portal can be fed directly from the customer's back-end information computer system, such as an intranet. In one embodiment, individual employees of a customer company can choose what types of information they will receive in area 432. This option is discussed in connection with “Profile” button 462 in the navigation toolbar 455.

In some embodiments (not depicted) area 432 contains links to other web sites containing more detailed financial information.

Kiosk area 435 in the embodiment depicted in FIG. 4 provides access to various publications that may be of interest to the user, in various categories, including newspapers, trade press, broadcast, web-sites, internal, and other. The set of categories presented typically varies from customer to customer, based on the survey results, and feedback from the customers to the provider. In some embodiments, moving a mouse cursor over one of the categories presents a pop-up window, which provides links to publications under that category. “Clicking” on one of these links will operate to provide access to a particular publication. In some embodiments, the links are customized to suit the needs of each customer.

Area 440 provides streaming headlines from third party news and information providers. In some embodiments, clicking on a headline provides a large pop-up window containing the story designated by the headline. The streaming news is customized for each customer, and can be further customized for each user using the “profile” function discussed below.

Area 445 provides a space for announcements of upcoming events of interest to the customer.

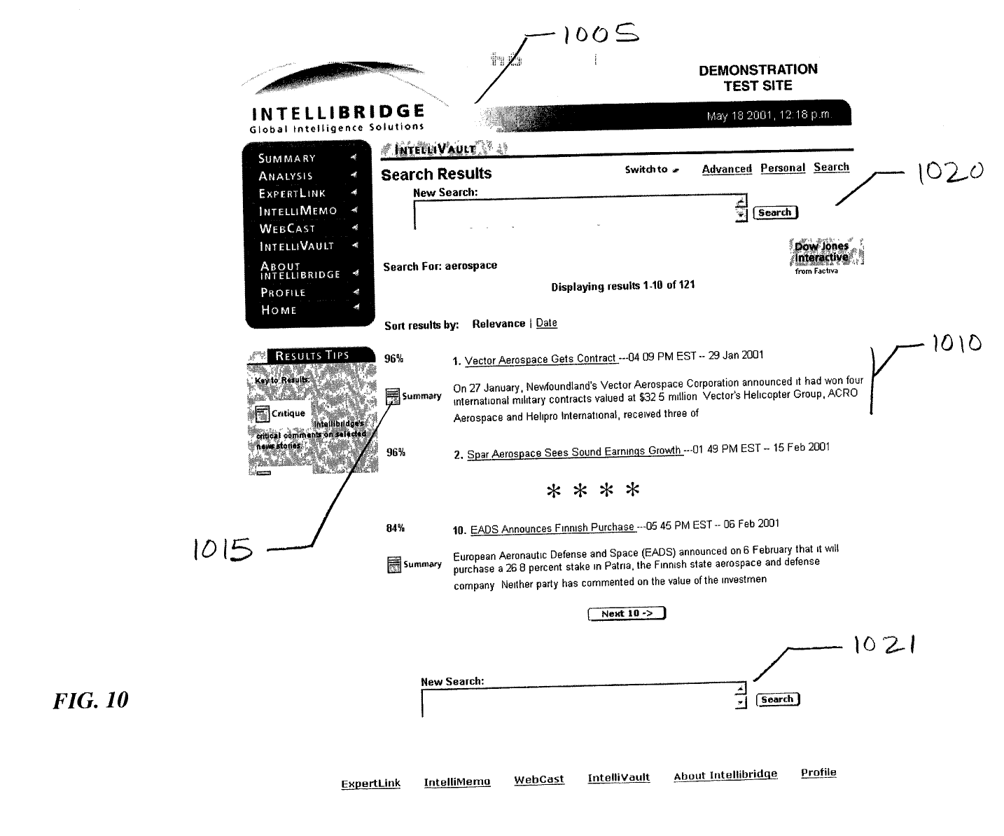

Area 450 provides access to the database containing information stored by the invention. The database can contain all information that has been available through the information portal, including summary stories, in-depth analyses, webcasts, source articles, and learning modules. In addition, the database can contain content such as stories from third party providers that were used in preparation of the summaries and analyses. As depicted in FIG. 4, a user can enter a search query directly in field 451. In this embodiment, entering a search query and clicking find button 452 calls up screen 1005 of FIG. 10 (asterisks on FIG. 10 denote omitted material). In some embodiments, searching enables the user to search not only the provider's database, but also the designated databases of the customer itself.

Screen 1005 presents the results of the search. In the depicted embodiment, the search results are sorted by relevance. In this embodiment, each search result 1010 is presented with its headline, date, as well as the first three lines of the story. To the left of each search result is an icon 1015 indicating whether the item is a “summary”, an “analysis” or a “critique.” In this embodiment, the user can conduct a new search using new search fields 1020 or 1021 on FIG. 10.

Returning to FIG. 4, navigation bar 455 provides the user ready access to different features of the invention. In some embodiments, a navigation bar similar to navigation bar 455 is available on some or all of the screens (including, for example, the summary screen and the in-depth analysis screen) that the user may encounter when using the information portal. In these embodiments, navigation bars appearing on screens other than an information portal screen (such as that depicted in FIG. 4), contain an additional tab labeled “Home” (as depicted in FIG. 8), which provides single-click access back to the information portal screen. In some embodiments, a navigation bar can contain a tab labeled “Chat,” for accessing a chatroom accessible to some or all of the information portal's users.

Returning to FIG. 4, moving a mouse cursor over summary button 456 causes a pop-up display listing the regions for which news items are available. Moving the mouse cursor to any of these regions displays a list of headlines of summary items available for that region. Clicking on any of these headlines provides access to the summary screen. The summary screen is described in connection with FIG. 5, above.

On FIG. 4, moving a mouse cursor over analysis button 457 causes a pop-up display of a list of in-depth analyses available for the customer. Clicking on an item on this list provides access to the analysis screen for that item. The analysis screen is described in connection with FIG. 6, above.

Clicking on ExpertLink button 458 calls up an expert emailing screen similar to the emailing screen depicted in FIG. 7, discussed above. In one embodiment, when the expert emailing is called up from the navigation bar, the “To” line is automatically filled in. In another embodiment, the user is given the option of browsing through a list of experts to and choosing the expert to whom to direct the email.

Clicking on Webcast button 460 provides the same functionality as described in connection with clicking webcast tab 425. Clicking database button 461 calls up a search page that enables the user to search the database, as discussed in connection with database area 450 and FIG. 10.

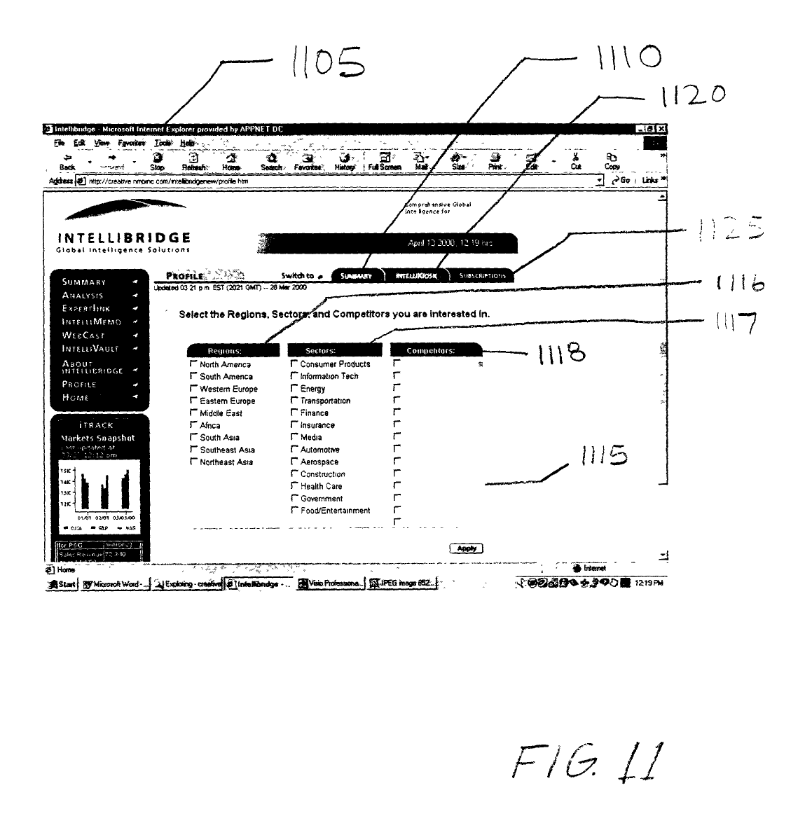

In the depicted embodiment, clicking “Profile” button 462 calls up screen 1105 of FIG. 11. On screen 1105, the summary tab 1110 has been selected, and area 1115 enables the user to select the regions, sectors, and competitors for which he wants information displayed on his information portal. In this embodiment, the regions list 1116 includes all regions, from which the user must select three. Sectors list 1117 lists the set of sectors (subject matter areas) identified for the customer in the survey and feedback from the customer to the provider. The user can select any or all of these sectors. Competitors list 1118 comprises a list of competitors generated as a result of the survey and subsequent feedback. The user may select any or all competitors, and the competitor information is then displayed in area 432 of the screen 405 on FIG. 4.

On screen 1105, selecting intellikiosk tab 1120 calls up a display in area 1115 that enables the user to select the categories of publications which the user is interested in having access to via the kiosk button 435 on FIG. 4, and subscription tab 1125 enables the user to choose the specific publications in those categories.

In some embodiments, the “profile” function gives the user the ability to indicate whether he wants e-mail notification of stories, emails containing the stories themselves, email notification of webcasts, or faxes of summaries and/or in-depth analyses. In some embodiments, for privileged users, the user is allowed to add a topic or theme to the coverage assignments of the provider's analysts. In some embodiments, the “profile” function provides designated users an email link that enables them to comment on the quality of the provider's products and request changes, upgrades and modifications.

In some embodiments, the “profile function” can be used to specify the language in which the user wishes to view the intelligence portal and/or associated items. Thus, a user can select to have the portal displayed in Spanish, and, in some embodiments, can elect to receive Spanish-language translations of items, and Spanish subtitles (or voiceovers) on any video feeds. Such translations can be generated using translation software or human translators, or a combination thereof.

In some embodiments, the profile feature further enables users to save their database searches for future reference (a function that can also be implemented on the database query screen), and to select to have certain items, including summaries or in-depth analyses meeting certain individually-selected criteria, emailed to them. In some embodiments, the user can elect to be paged or notified by some other means when particular items become available, in order to ensure that users can immediately access information that may be of particular importance to them.

In yet other embodiments, a user's ability to create a personal profile is limited, or can be controlled by supervisors within the customer. The ability to control or prevent individuals from creating their own profiles can be important to a company that places importance on all users having the same information. For this reason, in some embodiments, individual customization is not an option.

The above-described preferred embodiments are intended to illustrate the principles of the invention, but not to limit its scope. Various other embodiments, modifications and equivalents to these preferred embodiments may occur to those skilled in the art upon reading the present disclosure or practicing the claimed invention. Such variations, modifications and equivalents are intended to come within the scope of the invention and the appended claims.

What is claimed is:

1. A method for providing customized information to an aggregation of users having a common affiliation, comprising the steps of:
obtaining survey data indicative of whether a category is a topic of interest to said aggregation of users; and
based on said survey data, designing a customized report for providing information to said aggregation of users.

2. The method of claim 1, wherein said category is predefined.

3. The method of claim 1, wherein said information is time-sensitive.

4. The method of claim 1, wherein the customized report is an information portal accessible to a user on a computer network.

5. The method of claim 4, wherein the users are employees of the same business.

6. The method of claim 1, wherein said report-designing step comprises selecting, for an aggregation of users, the categories of information that said users will be presented with in a report.

7. The method of claim 6, where the report is an information portal accessible to a user on a computer network.

8. The method of claim 7, wherein the category selection step is performed by an analyst.

9. The method of claim 8, wherein said analyst is an employee of a provider of said information portal.

10. The method of claim 9, wherein said analyst has access to an expert in the subject matter of at least one category.

11. The method of claim 9, further comprising the step of providing said user the ability to send an email directly to one of said expert and said analyst.

12. The method of claim 11, wherein an item on said information portal contains means for directly emailing the author of said item.

13. The method of claim 1, wherein said survey comprises an interview.

14. The method of claim 1, wherein said survey comprises a written document filled out by a user.

15. An information portal for providing customized information to an aggregation of users over a network, comprising:
means for displaying a plurality of news summaries for a plurality of regions; and
means for displaying stock market information.

16. The information portal of claim 15, wherein said news summaries comprise approximately 30-70% factual material and approximately 30-70% analysis.

17. The information portal of claim 16, wherein said analysis is customized for said aggregation of users.

18. A graphical user interface for providing customized information comprising:
a plurality of areas on a computer screen, said plurality of areas comprising an area displaying a first plurality of headlines, each of said first plurality of headlines corresponding to a regional news summary item, and a second plurality of headlines, each of said second plurality of headlines corresponding to an in-depth analysis item,
wherein by selecting a headline, a user can view the item corresponding to said headline.

19. A server system for providing an information portal comprising: an information portal component, said information portal component comprising means for displaying, on a user's computer screen, a graphical user interface for providing access to content selected based on a survey conducted on an aggregation of users; and
an information retrieval component comprising:
a data storage medium for storing information for display on said graphical user interface,
a receiving component for receiving requests for information stored on said data storage medium, and
a retrieving component, responsive to said receiving component, for retrieving information stored on said data storage medium, and
a transmitting component, for transmitting data retrieved from said data storage medium to said information portal component.

20. A method for providing timely access to expertise using a client system, the method comprising:
displaying an information portal, said information portal providing access to a screen displaying an item selected based on a survey of an aggregation of users, wherein said item was item written by an individual having an email address; and
in response to a selection by a user on said item-displaying screen, displaying a screen adapted for writing an email to said individual.

21. The method of claim 20, wherein said information portal contains information related to news from a plurality of regions.

22. A method of providing customized information through an information portal, comprising:
conducting a survey of an aggregation of users;
receiving results of said survey;
selecting, responsive to said results receiving step, a plurality of categories of information; and
providing access to information falling in said plurality of categories to said aggregation of users.

23. An article of manufacture comprising an information storage medium encoded with a computer-readable data structure for use in connection with serving an information portal, comprising:
means for displaying, on a user's computer screen, a graphical user interface for providing access to content selected based on a survey conducted on an aggregation of users:
means for receiving a request for specific information from said user;
means, responsive to said receiving means, for retrieving specific information responsive to said user request; and
means for displaying said specific information to said user.

24. An article of manufacture comprising a propagated signal, said signal having encoded therein machine-readable information comprising information related to an information portal for providing customized information, said customized information being selected in response to a survey of an aggregation of users, and said customized information comprising regional news information being displayed under headings that identify a plurality of regions.

25. A method for generating customized information, comprising the steps of:
receiving attribute data for a record residing on a data communications network;
storing said attribute data in a first data bank;
generating a reference in a second data bank based on said attribute data, said reference being indicative of a category to which said record relates;
obtaining survey data indicative of whether said category is a topic of interest to a user;
providing an analyst to analyze said survey data, said analyst retrieving said attribute data from said first data bank based on said category and said reference; and
generating a report based on said survey data and said attribute data.

26. The method of claim 25, wherein said category is predefined.

27. The method of claim 25, wherein said attribute data includes data representative of one or more of the following properties:
the contents of said record,
a network addressable location for said record,
an age of said record,
an author of said record,
a publisher of said record, and
a link to another record.

28. The method of claim 25, wherein said step of generating a reference includes the step of training a neural network processor to recognize whether said record relates to said category.

29. The method of claim 28, wherein said training step includes:
defining a set of categories;
identifying a set of training records;
presenting said neural network processor with said training records;
identifying a set of sample testing records; and
presenting said neural network processor with said sample testing records.

30. The method of claim 25, wherein said reference is one of a plurality of references generated by said step of generating a reference, said plurality of references being indicative of a plurality of categories to which said record relates.

31. The method of claim 25, wherein said step of generating a report includes producing a summary of the contents of said record.

32. The method of claim 25, wherein said step of generating a report includes producing an analysis of the contents of said record.

33. The method of claim 25, wherein said step of generating a report includes providing access to the contents of said record.

34. The method of claim 25, wherein said step of generating a report includes providing access to a different record from said data communications network, said different record containing data related to said category.

35. The method of claim 25, wherein said step of generating a report includes providing means for sending said report to a different user.

36. The method of claim 25, wherein said step of generating a report includes providing means for communicating with an author of said report.

37. The method of claim 25, further comprising the steps of:
generating index data for said first data bank; and
retrieving said attribute data from said first data bank based on said index data.

38. The method of claim 25, further comprising the steps of:
storing said report; and
retrieving said report bank based on a condition.

39. The method of claim 38, further comprising the steps of:
receiving a request from said user for a different report; and
retrieving said different report from said third data bank.

40. The method of claim 25, further comprising the steps of:
storing said record; and
retrieving said record based on said category.

41. The method of claim 25, wherein said record comprises a prior report wherein said prior report was generated by said method of claim 25.

42. The method of claim 25, further comprising a step of producing a user profile configured to store preference information entered by said user.

43. The method of claim 25, further comprising a step of prohibiting unauthorized access to said report.

44. The method of claim 25, wherein said first data bank and said second data bank are the same.

45. The method of claim 25, wherein said data communications network is the Internet.

46. The method of claim 25, wherein said data communications network is a local area network.

47. The method of claim 25, further comprising the step of sending said report to said user.

48. The method of claim 47, wherein said sending step includes determining how said report is displayed to said user.

49. The method of claim 47, wherein said sending step includes publishing said report on the Internet.

50. The method of claim 47, wherein said sending step includes publishing said report on a local area network.

51. The method of claim 47, wherein said sending step includes publishing a link to said report on a home page for said user.

52. The method of claim 47, wherein said sending step includes publishing said report in an electronic mail message.

53. The method of claim 47, wherein said sending step includes publishing said report in a facsimile transmission.

54. The method of claim 25, further comprising a step of notifying said user that said report is available.

55. The method of claim 25, further comprising the step of transmitting a multimedia signal to said user.

56. The method of claim 55, wherein said step of transmitting a multimedia signal includes transmitting said multimedia signal from a multimedia server to a remote terminal under control of a multimedia user interface.

57. The method of claim 56, wherein said step of transmitting a multimedia signal comprises transmitting audio data.

58. The method of claim 56, wherein said step of transmitting a multimedia signal comprises transmitting a visual image.

59. The method of claim 56, wherein said step of transmitting a multimedia signal comprises:
transmitting audio data; and
transmitting visual images.

60. A computer-implemented method for generating customized information, comprising the steps of:
receiving, via a data communications network, attribute data for a record residing on said data communications network;
storing said attribute data in a first memory storage area;
generating a reference in a second memory storage area based on said attribute data, said reference being indicative of a category to which said record relates;
receiving survey data indicative of whether said category is a topic of interest to a user:
responsive to said survey data, retrieving said attribute data from said first memory storage area based on said category and said reference;
generating said customized report based on said survey data and said attribute data; and
transmitting said customized report to a remote terminal.

61. The method of claim 60, wherein said category is predefined.

62. The method of claim 60, wherein said attribute data includes data representative of one or more of the following properties:
the contents of said record,
a network addressable location for said record,
an age of said record,
an author of said record,
a publisher of said record, and
a link to another record.

63. The method of claim 60, wherein said step of generating a reference includes the step of training a neural network processor to recognize whether said record relates to said category.

64. The method of claim 63, wherein said training step includes:
defining a set of categories;
identifying a set of training records;
presenting said neural network processor with said training records;
identifying a set of sample testing records; and
presenting said neural network processor with said sample testing records.

65. The method of claim 60, wherein said reference is one of a plurality of references generated by said step of generating a reference, said plurality of references being indicative of a plurality of categories to which said record relates.

66. The method of claim 60, wherein said step of generating said customized report includes producing a summary of the contents of said record.

67. The method of claim 60, wherein said step of generating said customized report includes producing an analysis of the contents of said record.

68. The method of claim 60, wherein said step of generating said customized report includes providing a button configured to facilitate viewing the contents of said record.

69. The method of claim 60, wherein said step of generating said customized report includes providing a button configured to facilitate retrieving a different record from said data communications network, said different record containing data related to said category.

70. The method of claim 60, wherein said step of generating said customized report includes providing a button configured to facilitate transmitting said customized report to a different user.

71. The method of claim 60, wherein said step of generating said customized report includes providing a button configured to facilitate electronic communication with an author of said customized report.

72. The method of claim 60, further comprising the steps of:
generating index data for said first memory storage area; and
retrieving said attribute data from said first memory storage area based on said index data.

73. The method of claim 60, further comprising the steps of:
storing said customized report; and
retrieving said customized report based on a condition.

74. The method of claim 73, further comprising the steps of:
receiving a request from said user for a different customized report; and
retrieving said different customized report from said third memory storage area.

75. The method of claim 60, further comprising the steps of:
storing said record; and
retrieving said record based on said category.

76. The method of claim 60, wherein said record comprises a report previously generated by said method of claim 60.

77. The method of claim 60, wherein said step of transmitting said customized report further includes a step of determining how said report is displayed to said user.

78. The method of claim 60, further comprising a step of producing a user profile, configured to store preference information entered by said user.

79. The method of claim 60, further comprising a step of prohibiting unauthorized access to said customized report.

80. The method of claim 60, wherein said first memory storage area and said second memory storage area are the same.

81. The method of claim 60, wherein said data communications network is the Internet.

82. The method of claim 60, wherein said data communications network is a local area network.

83. The method of claim 60, wherein said transmitting step includes publishing said customized report on the Internet.

84. The method of claim 60, wherein said transmitting step includes publishing said customized report on a local area network.

85. The method of claim 60, wherein said transmitting step includes publishing a link to said customized report on a home page for said user.

86. The method of claim 60, wherein said transmitting step includes publishing said customized report in an electronic mail message.

87. The method of claim 60, wherein said transmitting step includes publishing said customized report in a facsimile transmission.

88. The method of claim 60, further comprising a step of notifying said user that said customized report is available.

89. The method of claim 60, further comprising the step of transmitting a multimedia signal to said user.

90. The method of claim 89, wherein said step of transmitting a multimedia signal includes transmitting, under control of a multimedia user interface, said multimedia signal from a multimedia server to a remote terminal.

91. The method of claim 90, wherein said step of transmitting a multimedia signal comprises transmitting audio data.

92. The method of claim 90, wherein said step of transmitting a multimedia signal comprises transmitting a visual image.

93. The method of claim 90, wherein said step of transmitting a multimedia signal comprises:
transmitting audio data; and
transmitting visual images.

94. An apparatus for generating customized information, comprising:
means for receiving attribute data for a record residing on a data communications network from said data communications network, and for storing said attribute data in a first data bank;
means for generating, based on said attribute data, a reference in a second data bank, said reference being indicative of a category to which said record relates;
means for obtaining survey data indicative of whether said category is a topic of interest to said user;
means, for retrieving said attribute data from said first data bank based on said category and said reference; and
means for generating a report based on said survey data and said attribute data.

95. The method of claim 94, wherein said category is predefined.

96. The apparatus of claim 94, wherein said attribute data includes data representative of one or more of the following properties:
the contents of said record,
a network addressable location for said record,
an age of said record,
an author of said record,
a publisher of said record, and
a link to another record.

97. The apparatus of claim 94, wherein said means for generating a reference comprises a neural network processor that is trained to recognize whether said record relates to said category.

98. The apparatus of claim 94, wherein said reference is one of a plurality of references generated by said means for generating a reference, said plurality of references being indicative of a plurality of categories to which said record relates.

99. The apparatus of claim 94, wherein said report comprises a summary of the contents of said record.

100. The apparatus of claim 94, wherein said report comprises an analysis of the contents of said record.

101. The apparatus of claim 94, wherein said report includes means for viewing the contents of said record.

102. The apparatus of claim 94, wherein said report includes means for retrieving a different record from said data communications network, said different record containing data related to said category.

103. The apparatus of claim 94, wherein said report includes means for transmitting said report to a different user.

104. The apparatus of claim 94, wherein said report includes means for communicating with an author of said report.

105. The apparatus of claim 94, further comprising means for indexing said first data bank; and means for retrieving said attribute data from said first data bank based on said means for indexing.

106. The apparatus of claim 94, further comprising:
means for storing said report; and
means for retrieving said report based on a condition.

107. The apparatus of claim 106, further comprising:
means for receiving a request from said user for a different report; and
means for retrieving said different report from said third data bank.

108. The apparatus of claim 94, further comprising:
means for storing said record in a fourth data bank;
and means for retrieving said record from said fourth data bank based on said category.

109. The apparatus of claim 94, wherein said record comprises a report previously generated by said apparatus of claim 94.

110. The apparatus of claim 94, further comprising means for storing preference information entered by said user.

111. The apparatus of claim 94, further comprising security means for prohibiting unauthorized access to said report.

112. The apparatus of claim 94, further comprising means, under control of said security means, for generating a profile for said user.

113. The apparatus of claim 112, wherein said profile comprises one or more preferences for transmitting said report to said user.

114. The apparatus of claim 113, wherein said profile comprises one or more preferences for displaying said report to said user.

115. The apparatus of claim 94, wherein said first data bank and said second data bank are the same.

116. The apparatus of claim 94, wherein said data communications network is the Internet.

117. The apparatus of claim 94, wherein said data communications network is a local area network.

118. The apparatus of claim 94, further comprising means for sending said report to said user.

119. The apparatus of claim 118, wherein said means for sending comprises means, coupled to said means for retrieving said attribute data from said first data bank, for determining how said report is displayed to said user.

120. The apparatus of claim 118, wherein said means for sending includes means for publishing said report on the Internet.

121. The apparatus of claim 118, wherein said means for sending includes means for publishing said report on a local area network.

122. The apparatus of claim 118, wherein said means for sending includes means for publishing a link to said report on a home page for said user.

123. The apparatus of claim 118, wherein said means for sending includes means for publishing said report in an electronic mail message.

124. The apparatus of claim 118, wherein said means for sending includes means for publishing said report in a facsimile transmission.

125. The apparatus of claim 94, further comprising means for notifying said user that said report is available.

126. The apparatus of claim 94, further comprising means for transmitting a multimedia signal to said user.

127. The apparatus of claim 126, wherein said means for transmitting a multimedia signal includes:
a multimedia user interface; and
means for transmitting, under control of said multimedia user interface, said multimedia signal from a multimedia server to a remote terminal.

128. The apparatus of claim 127, wherein said multimedia signal includes means for transmitting audio data.

129. The apparatus of claim 127, wherein said means for transmitting a multimedia signal includes means for transmitting a visual image.

130. The apparatus of claim 127, wherein said means for transmitting a multimedia signal includes:
means for transmitting audio data; and
means for transmitting a visual image.

131. An apparatus for generating customized information, comprising:
a content aggregator connection configured to receive attribute data for a record residing on a data communications network from said data communications network, and to store said attribute data in a first data bank;
a categorizer/indexer configured to generate a reference in a second data bank based on said attribute data, said reference being indicative of a category to which said record relates;
a search engine that retrieves said attribute data from said first data bank based on said category and said reference; and
a data analyst, operating in response to a determination that said category is a topic of interest to a user, that produces a report based on said attribute data.

132. The method of claim 131, wherein said category is predefined.

133. The apparatus of claim 131 wherein said determination is made based on a survey administered to said user.

134. The apparatus of claim 131, wherein said attribute data includes data representative of one or more of the following properties:
the contents of said record,
a network addressable location for said record,
an age of said record,
an author of said record,
a publisher of said record, and
a link to another record.

135. The apparatus of claim 131, wherein said categorizer/indexer includes a neural network processor that is trained to recognize whether said record relates to said category.

136. The apparatus of claim 131, wherein said reference is one of a plurality of references generated by said categorizer/indexer, said plurality of references being indicative of a plurality of categories to which said record relates.

137. The apparatus of claim 131, wherein said report comprises a summary of the contents of said record.

138. The apparatus of claim 131, wherein said report comprises an analysis of the contents of said record.

139. The apparatus of claim 131, wherein said report includes a button configured to facilitate viewing the contents of said record.

140. The apparatus of claim 131, wherein said report includes a button configured to facilitate retrieving a different record from said data communications network, said different record containing data related to said category.

141. The apparatus of claim 131, wherein said report includes a button configured to facilitate transmitting said report to a different user.

142. The apparatus of claim 131, wherein said report includes a button configured to facilitate electronic communication with an author of said report.

143. The apparatus of claim 131, further comprising:
an index for said first data bank; and
a search engine that retrieves said attribute data from said first data bank based on said index.

144. The apparatus of claim 131, further comprising:
a third data bank for storing said report; and
a report search engine configured to retrieve said report from said third data bank based on said category.

145. The apparatus of claim 144, wherein said first data bank, said second data bank and said third data bank are the same.

146. The apparatus of claim 131, further comprising:
a fourth data bank for storing said record; and
a record search engine configured to retrieve said record from said fourth data bank based on said category.

147. The apparatus of claim 146, wherein said first data bank, said second data bank and said fourth data bank are the same.

148. The apparatus of claim 131, wherein said record comprises a prior report, wherein said prior report was generated by said apparatus 131.

149. The apparatus of claim 131, further comprising a user profile module, configured to store preference information entered by said user.

150. The apparatus of claim 131, further comprising a security module that prohibits unauthorized access to said report.

151. The apparatus of claim 131, further comprising a profile generator, under control of said security module, that generates a profile for said user.

152. The apparatus of claim 131, wherein said profile includes one or more preferences for transmitting said report to said user.

153. The apparatus of claim 152, wherein said profile includes comprises one or more preferences for displaying said report to said user.

154. The apparatus of claim 131, wherein said first data bank and said second data bank are the same.

155. The apparatus of claim 131, wherein said data communications network is the Internet.

156. The apparatus of claim 131, wherein said data communications network is a local area network.

157. The apparatus of claim 131, further comprising a report transmitter that transmits said report to said user.

158. The apparatus of claim 157, wherein said report transmitter includes a user interface engine, coupled to said search engine, that determines how said report is displayed to said user.

159. The apparatus of claim 157, wherein said report transmitter publishes said report on the Internet.

160. The apparatus of claim 157, wherein said report transmitter publishes said report on a local area network.

161. The apparatus of claim 157, wherein said report transmitter publishes a link to said report on a home page for said user.

162. The apparatus of claim 157, wherein said report transmitter publishes said report in an electronic mail message.

163. The apparatus of claim 157, wherein said report transmitter publishes said report in a facsimile transmission.

164. The apparatus of claim 131, further comprising a messaging system that notifies said user that said report is available.

165. The apparatus of claim 131, further comprising a multimedia subsystem.

166. The apparatus of claim 165, wherein said multimedia subsystem includes:
a multimedia user interface; and
a multimedia server, operating under control of said multimedia user interface, configured to transmit said multimedia signal to a remote terminal.

167. The apparatus of claim 166, wherein said multimedia signal includes audio data.

168. The apparatus of claim 166, wherein said multimedia signal includes a visual image.

169. The apparatus of claim 168, wherein said multimedia signal includes:
audio data; and
a visual image.
